(19) United States
(12) Patent Application Publication
(10) Pub. No.: US 2018/0231282 A1
(43) Pub. Date: Aug. 16, 2018

(54) AIR CONDITIONING SYSTEM CONNECTOR

(71) Applicant: FORD GLOBAL TECHNOLOGIES, LLC, Dearborn, MI (US)

(72) Inventor: Stephen John Meldrum, Leigh on Sea (GB)

(21) Appl. No.: 15/862,262

(22) Filed: Jan. 4, 2018

(30) Foreign Application Priority Data
Feb. 16, 2017 (GB) 1702497.7

(51) Int. Cl. F25B 41/00; B60H 1/00; B60H 1/32

(52) U.S. Cl. CPC F25B 41/003; B60H 2001/3286; F25B 2327/001; B60H 1/00571

(57) ABSTRACT

A vehicle air conditioning system connector is provided. The connector includes: a first supply port, a second supply port, a first return port, a second return port, a first branch port and a second branch port.

### TECHNICAL FIELD

The present disclosure relates to an air conditioning system connector for a motor vehicle and is particularly, although not exclusively, concerned with an air conditioning system connector configured to simplify assembly of the air conditioning system.

BACKGROUND

Vehicles, e.g. motor vehicles, may have multiple configurations in which they can be built on the vehicle production line. For example, a vehicle may have a first configuration, in which driver and passenger seats are provided in a front compartment of the vehicle, and a second configuration, in which additional passenger seats are also provided in a rear compartment of the vehicle.

Vehicles often comprise auxiliary systems that are provided within the occupant compartments of the vehicle for improving occupant comfort and entertaining passengers during a journey. For example, the vehicle may comprise a climate control system and a media system.

For configurations of the vehicle in which passenger seating is provided in additional compartments of the vehicle, such as a rear compartment, additional components may be provided within the auxiliary systems to extend the auxiliary system into the additional compartment. However, for some auxiliary systems, it may be challenging to extend the system into the additional compartment of the vehicle by the addition of components to the system. In such cases, it may be necessary for one or more components of the auxiliary system to be interchanged, depending on the configuration of the vehicle.

With reference to FIG. 1, a vehicle 1 comprising a front passenger compartment la may comprise a previously proposed Air Condition (AC) system 2. The AC system 2 may be provided as part of a climate control system of the vehicle. The AC system 2 comprises a compressor 4 configured to compress refrigerant within the system, to liquefy the refrigerant and pump the refrigerant around the system 2.

The AC system further comprises an evaporator 6. The evaporator 6 may be provided within the front passenger compartment 1a of the vehicle. The refrigerant evaporates within the evaporator 6 and reduces the temperature of the evaporator. Air is drawn into the vehicle and blown over and/or through the evaporator 6, such that heat is transferred from the air to the evaporator 6. The cooled air is then vented into the front passenger compartment 1a of the vehicle to cool the vehicle occupants.

The AC system 2 comprises a refrigerant supply line 8 configured to carry liquid refrigerant from the compressor 4 to the evaporator 6 and a refrigerant return line 10 configured to carry gaseous refrigerant from the evaporator 6 to the compressor 4.

The AC system 2 may further comprise a condenser, not shown. The condenser may be operatively disposed between the compressor 4 and the evaporator 6, e.g. on the refrigerant supply line. Heat that is transferred into the refrigerant in the evaporator 6, may be transferred out of the refrigerant at the condenser, e.g. into a flow of air passing over or through the condenser.

With reference to FIG. 2, the vehicle may be configured such that additional passenger seating is provided within an additional compartment 1b of the vehicle. When the vehicle 1 is configured in this way, it may be desirable to provide an additional evaporator 7 within the AC system 2. Air drawn into the vehicle may be passed over and/or through the additional evaporator 7 before being vented into the additional compartment 1b.

It may be desirable for refrigerant to be circulated to the additional evaporator 7 by the compressor 4. Hence, it may be desirable for the refrigerant supply and return lines to branch upstream and downstream of the evaporator 6 respectively, in order for liquid refrigerant to be supplied to the additional evaporator 7 and for gaseous refrigerant leaving the additional evaporator to be returned to the compressor 4.

The refrigerant supply line 8 and refrigerant return line 10 are typically continuous, rigid ducts and it may be undesirable to reconfigure the refrigerant supply line 8 and refrigerant return line 10 to include branches or junctions during assembly of the vehicle, e.g. on the vehicle production line. Hence, as depicted in FIG. 2, when the additional evaporator 7 is provided within the AC system 2 the refrigerant supply and return lines 8, 10 may be replaced with branched supply and return lines 9, 11. The branched supply line 9 and the return line 11 may each comprise a branch or spur 9a, 11a to allow additional refrigerant supply and return lines 12, 14 to be provided between the branches of the branched supply and return lines 9, 11 and the additional evaporator 7.

Providing different components within the AC system 2 depending on the configuration of the motor vehicle 1 leads to an increase in the numbers of components being stored and managed on the vehicle production line and in the complexity of the assembly process for the vehicle 1. Furthermore, if the motor vehicle is converted at a later date, e.g. following manufacture of the vehicle, to provide additional seats within the additional compartment 1b of the vehicle, it may be necessary to replace the existing components of the AC system 2 in order to extend the AC system into the additional compartment lb.

### SUMMARY

According to an aspect of the present disclosure, there is provided, a vehicle air conditioning system connector comprising: (a) a first supply port configured to couple to a refrigerant supply line of an air conditioning system, wherein the first supply port comprises one of a first male connector and a first female connector; (b) a second supply port in fluid communication with the first supply port and configured to couple to an inlet of an evaporator of the air conditioning system, wherein the second supply port comprises the other of the first male and first female connector of the first supply port and is configured to correspond, e.g. in shape and size, to the first male or first female connector of the first supply port; (c) a first return port configured to couple to a refrigerant return line of the air conditioning system, wherein the first return port comprises one of a second male connector and a second female connector; a second return port in fluid communication with the first return port and configured to couple to an outlet of the evaporator, wherein the second return port comprises the other of the second male and second female connector of the first return port and is configured to correspond, e.g. in shape and size, to the second male or second female connector of the first return port; (d) a first branch port in fluid communication with the first supply port and configured to allow a further evaporator to be coupled to the air conditioning system in fluid communication with the refrigerant supply line; and (e) a second branch port in fluid communication with the first return port and configured to allow the further evaporator to be coupled to the air conditioning system in fluid communication with the refrigerant return line, wherein the first and second branch ports are configured such that flow paths defined by the first and second branch ports are arranged at an angle relative to each other.

The refrigerant supply line may comprise a connecting portion configured to couple to the connector of the first supply port. The connecting portion of the refrigerant supply line may be couplable, e.g. directly couplable, to the inlet of the evaporator. The connector of the second supply port may be the same shape as the connecting portion of the refrigerant supply line. The refrigerant return line may comprise a connecting portion configured to couple to the connector of the first return port. The connecting portion of the refrigerant return line may be couplable, e.g. directly couplable, to the outlet of the evaporator. The connector of the second return port may be the same shape as the connecting portion of the refrigerant return line.

The connector of the second supply port may therefore be couplable to the connector of the first supply port of a similar connector. Similarly, the connector of the second supply port may be couplable to the connector of the first supply port of a similar connector.

The connector may be configured to be mounted on the evaporator. For example, the connector may comprise a bore configured to receive a fastener for coupling the connector to the evaporator.

The first and second supply ports and the first and second return ports may be integrally formed on the connector, e.g. on a body of the connector.

The connector may define a supply passage configured to carry refrigerant between the first and second supply ports. The connector may define a return passage configured to carry refrigerant between the first and second return ports. The first and second branch ports may be configured such that flow paths defined by the first and second branch ports are arranged at right angles, e.g. at substantially 90 degrees, to the flow of refrigerant in the supply passage and return passage respectively.

The first and second branch ports may be arranged at substantially 90 degrees to each other.

The first and second branch ports may be configured such that flow paths, e.g. flow path lines, defined by the first and second branch ports are arranged in the same plane as one another.

Alternatively, the first and second branch ports may be configured such that flow paths, e.g. flow path lines, defined by the first and second branch ports are arranged in planes that are parallel to and offset from one another.

A vehicle air conditioning system may comprise: a refrigerant pump; a first evaporator; and the above-mentioned vehicle air conditioning system connector. The second supply port of the connector may be coupled to an inlet of the first evaporator and the second return port of the connector may be coupled to an outlet of the first evaporator. The vehicle air conditioning system may further comprise a refrigerant supply line coupled to the first supply port of the connector and in fluid communication with an outlet of the refrigerant pump and a refrigerant return line coupled to the first return port of the connector and in fluid communication with an inlet of the refrigerant pump.

The refrigerant supply line may be couplable, e.g. directly couplable, to the inlet of the first evaporator, e.g. if the vehicle air conditioning system connector was omitted. The refrigerant return line may be couplable, e.g. directly couplable, to the outlet of the first evaporator, e.g. if the vehicle air conditioning system connector was omitted.

The system may further comprise a second evaporator. An inlet of the second evaporator may be in fluid communication with the first branch port of the vehicle air conditioning system connector. An outlet of the second evaporator may be in fluid communication with the second branch port of the vehicle air conditioning system connector. For example, a further refrigerant supply line may be provided between the first branch port and the inlet of the second evaporator. Similarly, a further refrigerant return line may be provided between the second branch port and the outlet of the second evaporator.

The vehicle air conditioning system connector may be mounted on the first evaporator, e.g. directly coupled to the first evaporator using one or more fasteners.

At least a portion of the refrigerant supply line and at least a portion of the refrigerant return line may be flexible. This may enable the refrigerant supply line and refrigerant return line to be flexed in order to couple to the connector or the first evaporator, e.g. depending on the configuration of the vehicle air conditioning system.

According to another aspect of the present disclosure, there is provided a method of extending a vehicle air conditioning system, wherein the vehicle air conditioning system comprises: a refrigerant pump; an evaporator; a refrigerant supply line couplable to an inlet of the first evaporator and in fluid communication with an outlet of the refrigerant pump; and a refrigerant return line couplable to an outlet of the first evaporator and in fluid communication with an inlet of the refrigerant pump, wherein the method comprises: providing the above-mentioned vehicle air conditioning system connector; coupling the connector to the evaporator such that the second supply port of the connector is in fluid communication within the inlet of the evaporator and the second return port of the connector is in fluid communication with the outlet of the evaporator; coupling the refrigerant supply line to the first supply port of the connector; coupling the refrigerant return line to the first return port of the connector; and arranging an additional evaporator such that an inlet of the additional evaporator is in fluid communication with the first branch port of the connector and an outlet of the additional evaporator is in fluid communication with the second branch port of the connector.

For example, the method may further comprise: providing a further refrigerant supply line between the first branch port and the inlet of the second evaporator and providing a further refrigerant return line between the second branch port and the outlet of the second evaporator.

The method may further comprise decoupling the refrigerant supply line from the inlet of the evaporator. The method may further comprise decoupling the refrigerant return line from the outlet of the evaporator.

To avoid unnecessary duplication of effort and repetition of text in the specification, certain features are described in relation to only one or several aspects or embodiments of the vehicle air conditioning system connector. However, it is to be understood that, where it is technically possible, features described in relation to any aspect or embodiment of the vehicle air conditioning system connector may also be used with any other aspect or embodiment of the vehicle air conditioning system connector.

### BRIEF DESCRIPTION OF THE DRAWING FIGURES

For a better understanding of the present invention, and to show more clearly how it may be carried into effect, reference will now be made, by way of example, to the accompanying drawings, in which:

FIG. 1 is a schematic view of a first configuration of a previously proposed AC system for a motor vehicle;

FIG. 2 is a schematic view of a second configuration of a previously proposed AC system for a motor vehicle;

FIG. 3 is a schematic view of an AC system for a motor vehicle, according to arrangements of the present disclosure, installed in a motor vehicle having a first configuration;

FIG. 4 is a schematic view of the AC system for a motor vehicle, according to arrangements of the present disclosure, installed in a motor vehicle having a second configuration;

FIG. 5a is a cross-sectional view of an AC system connector, according to arrangements of the present disclosure;

FIG. 5b is a cross-sectional view of the AC system connector on line A-A;

FIG. 6a is a perspective view of the AC system connector and an evaporator of an the AC system in a disassembled configuration;

FIG. 6b is a perspective view of the AC system connector and an evaporator of an the AC system in an assembled configuration;

FIG. 7 is a schematic cross-sectional view of the AC system connector and an evaporator of an the AC system in the assembled configuration; and

FIG. 8 shows a method of extending an AC system for a motor vehicle, according to arrangements of the present disclosure.

### DETAILED DESCRIPTION

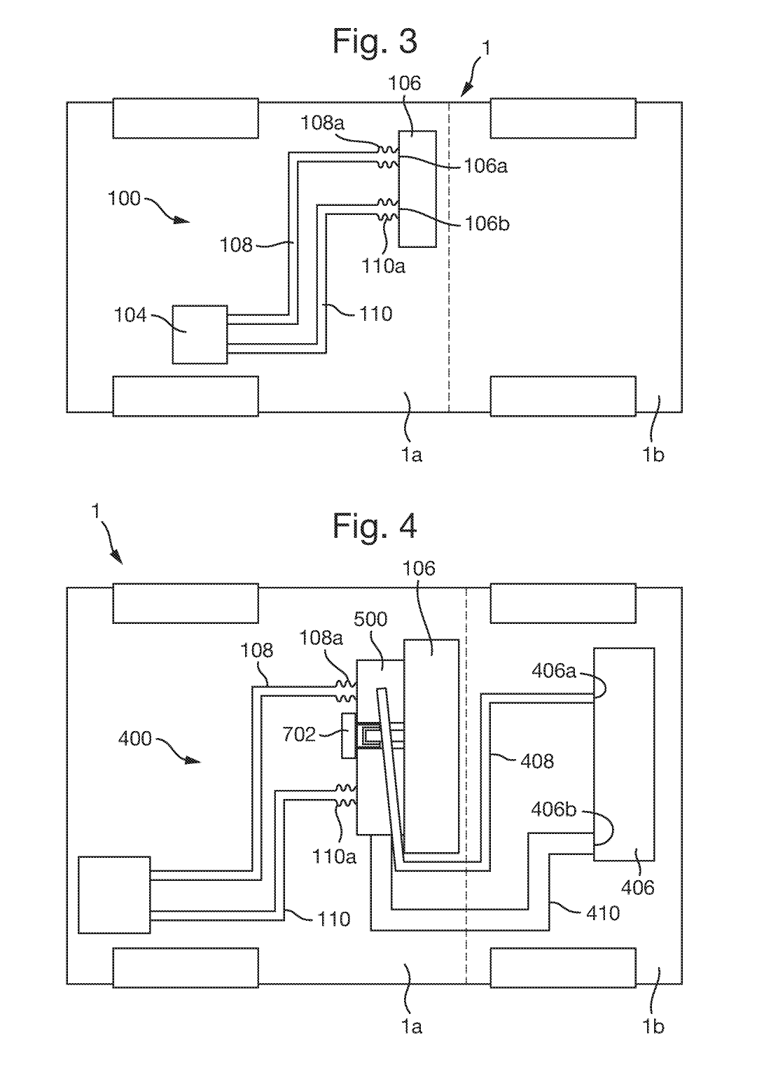

FIG. 3 depicts an AC system 100, according to arrangements of the present disclosure, which may be installed within the vehicle 1 instead of the previously proposed AC system 2. The AC system 100 depicted in FIG. 3 may be installed within the vehicle 1 when the vehicle is manufactured in a first configuration. The first configuration may be a configuration in which the occupant seating of the vehicle is provided within a single compartment of the vehicle, e.g. within the front compartment 1a.

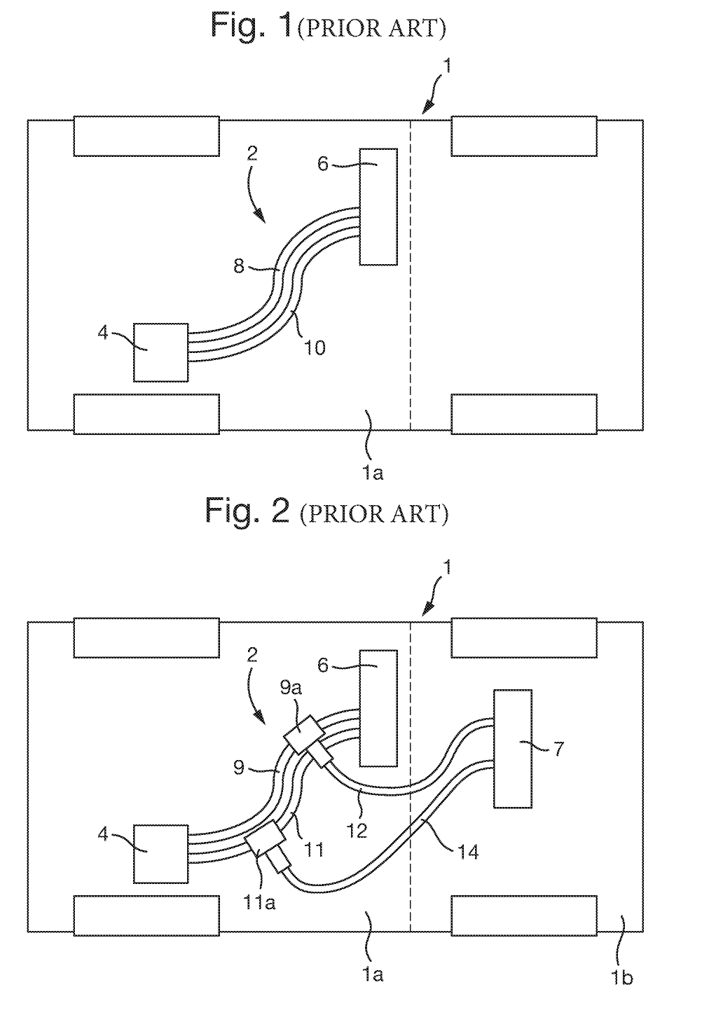

The AC system 100 comprises a compressor 104 and an evaporator 106. The compressor 104 and the evaporator 106 may be similar to the compressor 4 and evaporator 6 of the previously proposed AC system described above with reference to FIGS. 1 and 2. A condenser, not show, may also be provided.

The AC system 100 further comprises a refrigerant supply line 108, coupled to an inlet 106a of the evaporator, and a refrigerant return line 110, coupled to an outlet 106b of the evaporator. The refrigerant lines 108, 110 may be similar to the refrigerant lines 8, 10, except that the refrigerant lines 108, 110 may be configured to facilitate the extension of the AC system to include one or more additional evaporators, e.g. during the assembly process of the motor vehicle, as described below.

With reference to FIG. 4, the AC system can be extended to an extended AC system 400, which includes one or more additional evaporators 406. As shown, an AC system connector 500, according to arrangements of the present disclosure, is provided within the extended AC system 400. The AC system connector 500 is configured to enable the additional evaporator 406 to be connected into the system, e.g. via additional refrigerant supply and return lines 408, 410.

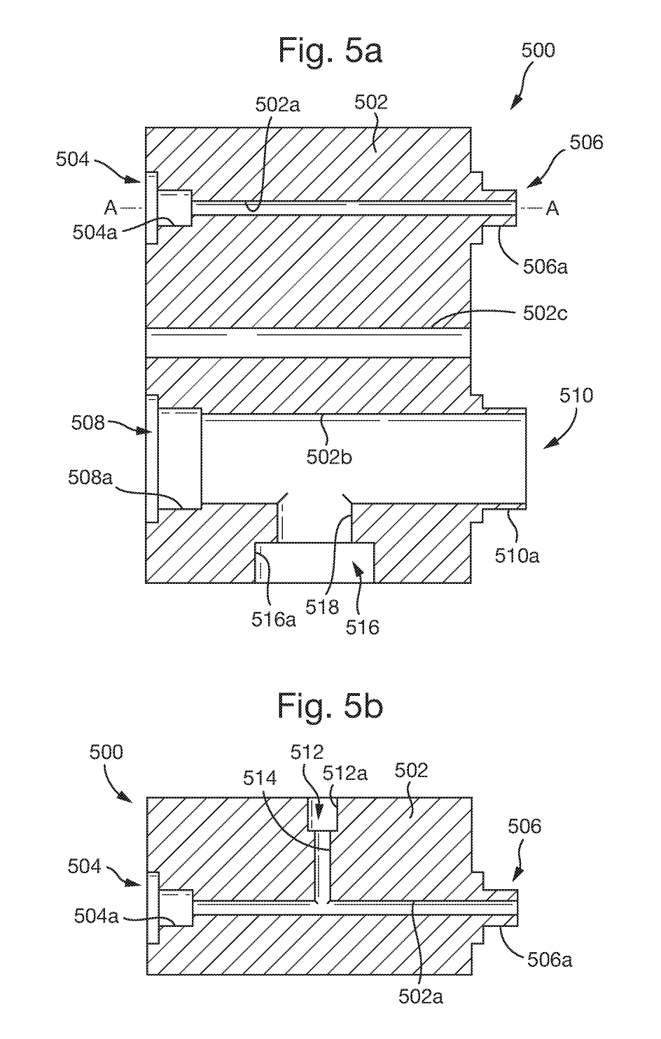

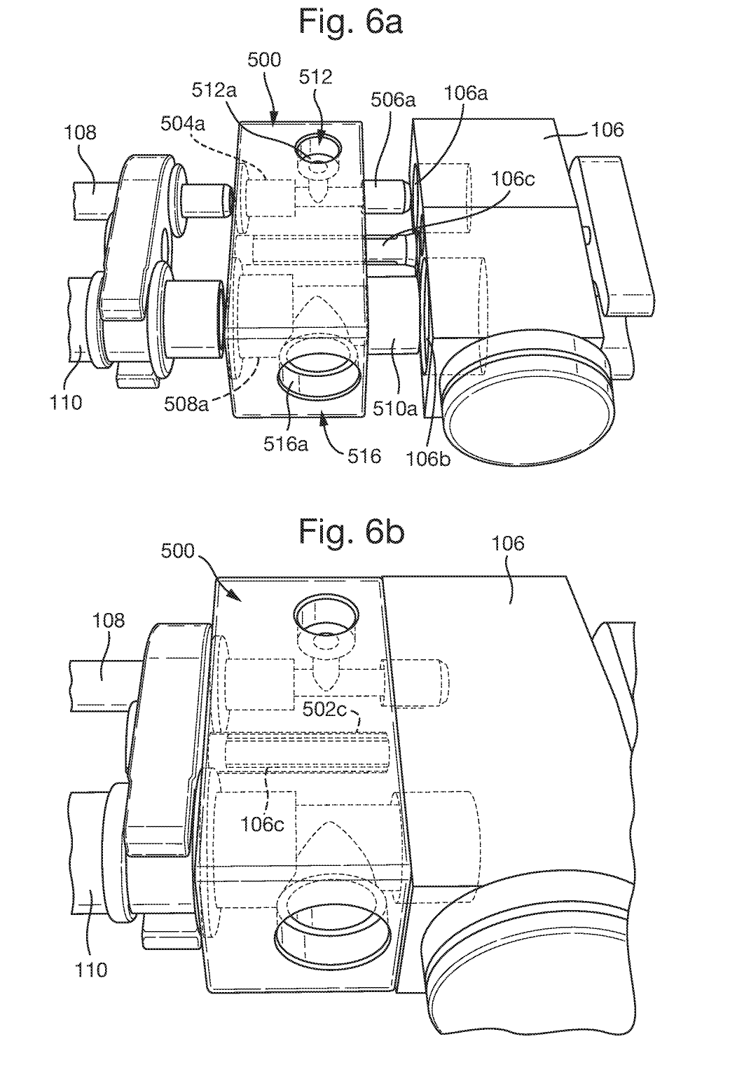

With reference to FIGS. 5a, 5b, 6a and 6b, a vehicle AC system connector 500 comprises a body portion 502, a first supply port 504, a second supply port 506, a first return port 508 and a second return port 510.

The first supply port 504 comprises a first female connecting portion 504a and the second supply port 506 comprises a first male connecting portion 506a. The male and female connecting portions correspond to one another, e.g. a space defined by the female connecting portion 504a may be the same shape and size as a protrusion defined by the male connecting portion 506a. In other words, the female connection portion 504a may be couplable to the male connecting portion 506a of another, similar vehicle AC system connector 500.

Although in the arrangement shown, the first supply port 504 comprises the female connecting portion and the second supply port 506 comprises the male connecting portion, it is also envisaged, that in other arrangements of the disclosure, the first supply port 504 may comprise the male connecting portion and the second supply port 506 may comprise the female connecting portion.

The first return port 508 comprises a second female connecting portion 508a and the second return port 510 comprises a second male connecting portion 510a. The male and female connecting portions 508a, 510a correspond to one another in the same way as the male and female connecting portions 504a, 506a defined by the first and second supply ports.

Although in the arrangement shown, the first return port 508 comprises the female connecting portion and the second return port 510 comprises the male connecting portion, it is also envisaged, that in other arrangements of the disclosure, the first return port 508 may comprise the male connecting portion and the second return port 510 may comprise the female connecting portion.

The vehicle AC system connector 500, e.g. the body portion 502, defines a supply passage 502a between the first and second supply ports 504, 506. In this way, the first and second supply ports are in fluid communication with each other.

The body portion 502 further defines a return passage 502b between the first and second return ports 508, 510. The first and second return ports are in fluid communication with each other via the return passage 502b.

In the arrangement depicted in FIGS. 5a, 5b, 6a and 6b, the return passage 502b has a larger diameter than the supply passage 502a. However, in other arrangements, the supply and return passages 502a, 502b may be the same diameter, or the supply passage may have a larger diameter than the return passage. The diameters of the supply and return passages 502a, 502b may correspond to the diameters of the supply and return ports 504, 506, 508, 510 respectively, e.g. the diameters of flow paths defined by the supply and return ports.

The first and second supply ports 504, 506 and the first and second return ports 508, 510 may be integrally formed on the vehicle AC system connector 500, e.g. on the body portion 502.

The vehicle AC system connector 500 further comprises a first branch port 512. As depicted in FIG. 5b, the first branch port 512 comprises a female connecting portion 512a. However, in other arrangements the first branch port 512 may comprise a male connecting portion.

The first branch port 512 is in fluid communication with the first and second supply ports 504, 506. For example, as depicted in FIG. 5b, a first branch passage 514 may branch from the supply passage 502a. The first branch port 512 may be in fluid communication with the first branch passage 514. The first branch passage 514 may be substantially the same diameter as the supply passage 502a. Alternatively, the diameter of the first branch passage 514 may be smaller or may be larger than the supply passage 502a

The first branch passage 514 may branch from the supply passage 502a at an angle relative to the supply passage 502a. In other words, a flow path defined by that first branch passage 514 may be at an angle relative to a flow path defined by the supply passage 502a. For example, the first branch passage 514 may branch from the supply passage 502a at an angle of substantially 90 degrees relative to the supply passage 502a. A flow path defined by first branch port 512 may be aligned, e.g. axially aligned, with the flow path defined by the first branch passage 514.

The vehicle AC system connector 500 further comprises a second branch port 516 (see FIG. 5a). The second branch port 516 is in fluid communication with the first and second return ports 508, 510. For example, the second branch port 516 may be in fluid communication with a second branch passage 518 that may branch from the return passage 502b.

The second branch passage 518 may be substantially the same diameter as the return passage 502b. Alternatively, the diameter of the second branch passage 518 may be smaller or may be larger than the return passage 502b. As depicted, the second branch passages 518 may have a larger diameter that the first branch passage 514. However, in other arrangements, the diameter of the second branch passage 518 may be the same as the first branch passage 514, or may be smaller.

The second branch passage 518 may branch from the return passage 502b at an angle relative to the return passage 502b, e.g. relative to the flow path defined by the return passage. For example, the second branch passage 518 may branch from the return passage 502b at an angle of substantially 90 degrees. A flow path defined by second branch port 516 may be aligned, e.g. axially aligned, with the flow path defined by the second branch passage 518.

The flow paths defined by the first and second branch ports 512, 516 may be arranged at an angle relative to one another. For example, the first and second branch ports 512, 516 may be arranged at an angle of substantially 90 degrees to each other. The flow paths defined by the first and second branch ports 512, 516 may be arranged in the same plane (which may be perpendicular to a longitudinal axis of passage 502a or 502b). Alternatively, the flow paths defined by the first and second branch ports 512, 516 may be arranged in planes that are parallel to and offset from one another. In some arrangements, the flow paths defined by the first and second branch ports 512, 516 may be arranged in a plane or planes that are perpendicular to the flow paths defined by the supply and return passages 502a, 502b.

The relative arrangements of the first and second branch ports 512, 516 may be configured in order to improve the packaging of additional supply and return lines that may be coupled to the first and second branch ports, as described below.

In the arrangement shown in FIGS. 5a, 5b, 6a and 6b, the first and second branch ports 512, 516 comprise female connecting portions 512a, 516a, configured to couple to the additional supply and return lines respectively, e.g. configured to receive a portion of the additional supply and return lines. However, it is also envisaged that the first and second branch ports 512, 516 may comprise male connecting portions for connecting to the additional supply and return lines, e.g. configured to be received by a portion of the additional supply and return lines respectively.

As shown in FIGS. 6a and 6b, the connecting portion 506a of the second supply port 506 may be couplable, e.g. directly couplable, to an inlet 106a of the evaporator 106 and the connecting portion 510a of the second return port 510 may be couplable, e.g. directly, couplable to an outlet 106b of the evaporator 106.

In some arrangements of the disclosure, the vehicle AC system connector 500 may be mounted on the evaporator 106. For example, the vehicle AC system connector 500 may be coupled to the evaporator 106 using one or more fasteners.

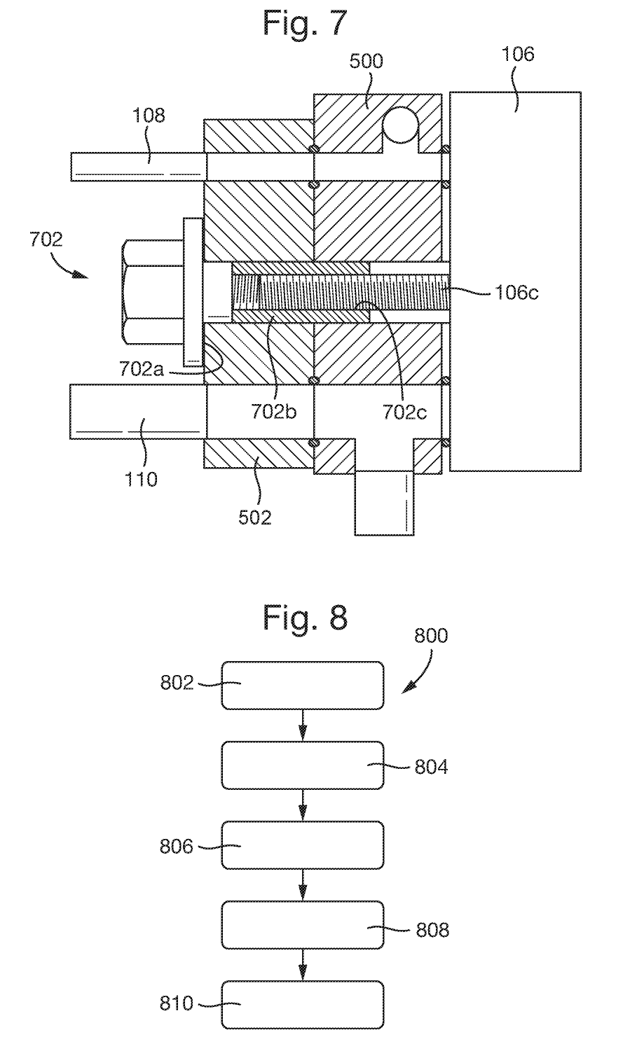

With reference to FIG. 7, the vehicle AC system connector 500 comprises a bore 702c configured to receive a fastening portion 106c of the evaporator. The bore 702c extends through the body portion 502 of the vehicle AC system connector.

The fastening portion 106c comprises a threaded shaft. The AC system 500 further comprises a fastening component 702 configured to be threaded onto the fastening portion 106c. The fastening component 702 comprises a shoulder 702a configured to abut the vehicle AC system connector 500, when the fastening component is threaded onto the fastening portion 106c, and clamp the vehicle AC system connector 500 against the evaporator 106.

As shown in FIG. 7, the fastening portion 106c of the evaporator may not extend through the bore 502c, e.g. through the full length of the bore. As depicted, the fastening component 702 comprises a shank 702b configured to be at least partially received within the bore 502c. The shank 702b comprises a bore having an internally threaded portion 702c configured to receive, e.g. be threaded on to, the fastening portion 106c. In this way the fastening component 702 may be configured to effectively extend the length of the fastening portion 106c of the evaporator when the AC system connector is provided within the system. As such, the fastening portion 106c of the evaporator, which may be a standard component, does not need to change to accommodate the connector 500.

With reference to FIG. 8, a method 800 of extending a vehicle air conditioning system according to arrangements of the present disclosure comprises a first step 802, in which the vehicle AC system connector 500 is provided.

The method 800 comprises a second step 804, in which the vehicle AC system connector 500 is coupled to the evaporator 106. The vehicle AC system connector 500 may be coupled to the evaporator 106 such that the second supply port of the connector 506 is in fluid communication with the inlet 106a of the evaporator and the second return port 510 of the vehicle AC system connector is in fluid communication with the outlet 106b of the evaporator.

The method 800 further comprises a third step 806, in which the refrigerant supply line 108 is coupled to the first supply port 504 of the vehicle AC system connector. As described above, the refrigerant supply line 108 may be provided within the arrangement of the AC system 100 depicted in FIG. 3, in which the refrigerant supply line 108 is coupled, e.g. directly coupled, to the inlet 106a of the evaporator. Hence, in order to allow the refrigerant supply line 108 to be provided within the arrangement shown in FIG. 4, at least a portion 108a of the refrigerant supply line may be flexible, e.g. compressible and/or extendible. The refrigerant supply line 108 may thereby be deformed, compressed and/or extended in order to allow the refrigerant supply line to be coupled to the first supply port 504 of the vehicle AC system connector 500 instead of the being coupled directly to the evaporator 106.

The method 800 may further comprise a fourth step 808, in which the refrigerant return line 110 is coupled to the first return port 508 of the vehicle AC system connector. At least a portion 110a of the refrigerant return line 110 may be flexible in order to allow the refrigerant supply line to be provided within the arrangements of the AC system 100 shown in FIGS. 3 and 4, e.g. in order to allow the refrigerant return line 110 to be coupled to the vehicle AC system connector 500 or directly to the evaporator 106 depending on the configuration of the AC system 100.

The method 800 may further comprise a fifth step 810, in which the additional evaporator 406 is provided. The additional evaporator may be provided within an additional compartment of the motor vehicle, such as the rear compartment 1b. As shown in FIG. 4, the additional evaporator may be arranged such that an inlet 406a of the additional evaporator is in fluid communication with the first branch port 512 of the vehicle AC system connector and an outlet 406b of the additional evaporator is in fluid communication with the second branch port 516 of the vehicle AC system connector. The additional supply line 408 may be provided between the first branch port 512 of the vehicle AC system connector 500 and the inlet of the additional evaporator 406, and the additional return line 410 may be provided between the second branch port 516 of the vehicle AC system connector and the outlet of the additional evaporator 406.

The method 800 described above may be used during an original manufacturing process of the vehicle AC system 100 when the AC system is to include an evaporator and an additional evaporator. For example when a vehicle, in which the AC system is to be installed, includes passenger seating within two or more compartments of the vehicle.

Additionally, the method 800 may be used to extend a previously manufactured AC system, e.g. in order to retrofit an additional evaporator to the AC system. For example, an additional evaporator may be retrofitted to a vehicle being converted to include passenger seating within an additional compartment of the vehicle. In this case, the method 800 may comprise additional steps in which the refrigerant supply line 108 is disconnected from the inlet 106a of the evaporator 106 and the refrigerant return line 110 is disconnected from the outlet 106b of the evaporator 106. These additional steps may be performed before the steps of the method 800 mentioned above.

It will be appreciated by those skilled in the art that although the vehicle air conditioning system connector has been described by way of example, with reference to one or more exemplary examples, it is not limited to the disclosed examples and that alternative examples could be constructed without departing from the scope of the invention as defined by the appended claims.

What is claimed:

1. A vehicle air conditioning system connector comprising:
a first supply port configured to couple to a refrigerant supply line of an air conditioning system, wherein the first supply port comprises one of a first male connector and a first female connector;
a second supply port in fluid communication with the first supply port and configured to couple to an inlet of an evaporator of the air conditioning system, wherein the second supply port includes the other of the first male connector and the first female connector of the first supply port and is configured to correspond to the first male connector or the first female connector of the first supply port;
a first return port configured to couple to a refrigerant return line of the air conditioning system, wherein the first return port comprises one of a second male connector and a second female connector;
a second return port in fluid communication with the first return port and configured to couple to an outlet of the evaporator, wherein the second return port comprises the other of the second male connector and the second female connector of the first return port and is configured to correspond to the second male connector or the second female connector of the first return port;
a first branch port in fluid communication with the first supply port and configured to allow a further evaporator to be coupled to the air conditioning system in fluid communication with the refrigerant supply line; and
a second branch port in fluid communication with the first return port and configured to allow the further evaporator to be coupled to the air conditioning system in fluid communication with the refrigerant return line, wherein the first branch port and the second branch port are configured such that flow paths defined by the first branch port and the second branch port are arranged at an angle relative to each other.

2. The vehicle air conditioning system connector of claim 1, wherein the vehicle air conditioning system connector is configured to be mounted on the evaporator.

3. The vehicle air conditioning system connector of claim 1, wherein the vehicle air conditioning system connector comprises a bore configured to receive a fastener for coupling the connector to the evaporator.

4. The vehicle air conditioning system connector of claim 3, wherein the first supply port and the second supply port and the first return port and the second return port are integrally formed on the vehicle air conditioning system connector.

5. The vehicle air conditioning system connector of claim 4, wherein the vehicle air conditioning system connector defines (a) a supply passage configured to carry refrigerant between the first supply port and the second supply port and (b) a return passage configured to carry refrigerant between the first return port and the second return port.

6. The vehicle air conditioning system connector of claim 5, wherein the first branch port and the second branch port are configured such that flow paths defined by the first branch port and the second branch port are arranged at right angles to a flow of refrigerant in the supply passage and return passage respectively.

7. The vehicle air conditioning system connector of claim 6, wherein the first branch port and the second branch port are configured such that flow paths defined by the first and second branch ports are arranged in the same plane.

8. The vehicle air conditioning system connector of claim 6, wherein the first branch port and the second branch port are configured such that flow paths defined by the first branch port and the second branch port are arranged in planes that are parallel and offset.

9. A vehicle air conditioning system comprising:
a refrigerant pump;
a first evaporator;
the vehicle air conditioning system connector of claim 1, wherein the second supply port of the vehicle air conditioning system connector is coupled to the inlet of the first evaporator and the second return port of the vehicle air conditioning system connector is coupled to the outlet of the first evaporator;
the refrigerant supply line coupled to the first supply port of the vehicle air conditioning system connector and in fluid communication with an outlet of the refrigerant pump; and
the refrigerant return line coupled to the first return port of the vehicle air conditioning system connector and in fluid communication with an inlet of the refrigerant pump.

10. The vehicle air conditioning system of claim 9, wherein the refrigerant supply line is couplable to the inlet of the first evaporator and the refrigerant return line is couplable to the outlet of the first evaporator.

11. The vehicle air conditioning system of claim 10, wherein the vehicle air conditioning system further comprises a second evaporator, wherein an inlet of the second evaporator is in fluid communication with the first branch port of the vehicle air conditioning system connector and an outlet of the second evaporator is in fluid communication with the second branch port of the vehicle air conditioning system connector.

12. The vehicle air conditioning system of claim 11, wherein the vehicle air conditioning system connector is mounted on the first evaporator.

13. The vehicle air conditioning system of claim 12, wherein at least the portion of the refrigerant supply line and at least a portion of the refrigerant return line are flexible.

14. A method of extending a vehicle air conditioning system, wherein the vehicle air conditioning system comprises:
a refrigerant pump;
an evaporator;
a refrigerant supply line couplable to an inlet of a first evaporator and in fluid communication with an outlet of the refrigerant pump; and
a refrigerant return line couplable to an outlet of the first evaporator and in fluid communication with an inlet of the refrigerant pump, wherein the method comprises:
providing a vehicle air conditioning system connector,
coupling the vehicle air conditioning system connector to the evaporator such that a second supply port of the vehicle air conditioning system connector is in fluid communication within the inlet of the evaporator and a second return port of the vehicle air conditioning system connector is in fluid communication with the outlet of the evaporator;
coupling the refrigerant supply line to a first supply port of the vehicle air conditioning system connector;
coupling the refrigerant return line to a first return port of the vehicle air conditioning system connector; and
arranging an additional evaporator such that an inlet of the additional evaporator is in fluid communication with a first branch port of the vehicle air conditioning system connector and an outlet of the additional evaporator is in fluid communication with a second branch port of the vehicle air conditioning system connector.

15. The method of claim 14, wherein the method further comprises:
decoupling the refrigerant supply line from the inlet of the evaporator; and
decoupling the refrigerant return line from the outlet of the evaporator.
